(19) United States
(12) Patent Application Publication
(10) Pub. No.: US 2026/0350174 A1
(43) Pub. Date: Nov. 5, 2026

(54) DETERMINING SECURITY RISK RELATED DAMAGE LIKELIHOOD ASSOCIATED WITH ARTIFICIAL INTELLIGENCE MODELS

(71) Applicant: NVIDIA Corporation, Santa Clara, CA (US)

(72) Inventor: Phani Bhushan Avadhanam, San Diego, CA (US)

(21) Appl. No.: 19/171,847

(22) Filed: Apr. 7, 2025

(51) Int. Cl. G06F 21/57

(52) U.S. Cl. CPC G06F 21/577; G06F 2221/033

(57) ABSTRACT

Devices, systems, and techniques for assessing and managing network security risks associated with an artificial intelligence (AI) model executed by a primary computing system. The techniques include receiving one or more executable files implementing the AI model. The techniques include scanning the one or more executable files implementing the AI model to identify a target attribute of the AI model. The techniques include executing one or more tests in a testing environment associated with a computing system hosting the AI model to generate test data associated with the target attribute. The techniques include generating, based on the test data, a damage likelihood score associated with the target attribute of the AI model.

### TECHNICAL FIELD

At least one embodiment pertains to assessing and managing network security risks associated with artificial intelligence models executed by a primary computing system. For example, at least one embodiment pertains to a primary computing system employing a risk assessment system to assess and determine a damage likelihood associated with an ingested artificial intelligence model.

### BACKGROUND

Computing systems frequently ingest data from various sources, which is then stored and shared with downstream users. Data that is received from a third-party source may expose the recipient computer system to potentially malicious files, such as objects that may be infected with malware, viruses, ransomware, trojan horses, and the like.

In particular, artificial intelligence (AI) models (e.g., language models such as large language models (LLMs), small language models (SLMs), vision language models (VLMs), and multimodal language models (MMLMs)) may be received and ingested by an application of a computing system associated with an organization (i.e., a recipient application). Disadvantageously, many AI models can be manipulated and abused by modifying one or more model attributes (e.g., model shapes, model operators, model inferences). Specifically, the model attributes can be susceptible to one or more security risk scenarios such as unauthorized model dumping, intellectual property theft or leakage, hyperparameter exposure, etc. In such cases, a bad-faith actor can build AI models (e.g., such as models in the ONNX format) including code configured to trigger security attacks on the recipient computing system and related application(s). Furthermore, such attacks perpetrated by a malicious AI model may expose not only the recipient application to risks, but also one or more downstream users of the application to potential malware infection on local user devices.

Defense systems associated with the ingesting computing system are frequently unable to recognize and assess a level or likelihood of security-related damage that is associated with AI models. This inability to determine and update damage likelihoods relating to an AI model renders systems, applications, services, and infrastructure vulnerable to malicious AI model code having unknown damage profiles.

### BRIEF DESCRIPTION OF DRAWINGS

FIG. 1 is a block diagram of an example damage likelihood assessment system communicatively coupled to one or more computing systems associated with one or more AI models to be consumed by one or more applications executed by one or more primary computing systems, in accordance with at least one embodiment;

FIG. 2 illustrates an example damage likelihood assessment engine of a damage likelihood assessment system configured to perform operations to generate a damage likelihood score associated with an example attribute associated with an ingested AI model.

FIG. 3 illustrates an example data structure including information associated with an example attribute of an ingested AI model, including initial damage likelihood scores and adjusted damage likelihood scores and corresponding risk levels, according to at least one embodiment;

FIG. 4 is a flow diagram of an example method related to generating a damage likelihood assessment associated with a target attribute of an AI model ingested for use by one or more applications executed by a primary computing system, in accordance with at least one embodiment;

FIG. 5A is a block diagram of an example generative language model system suitable for use in implementing some embodiments of the present disclosure;

FIG. 5B is a block diagram of an example generative language model that includes a transformer encoder-decoder suitable for use in implementing some embodiments of the present disclosure;

FIG. 5C is a block diagram of an example generative language model that includes a decoder-only transformer architecture suitable for use in implementing some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

A wide range of applications ingest and store data associated with an AI model (herein referred to collectively as an “AI model”). The applications further share that data with one or more downstream users. Frequently, the ingested data is received from one or more third-party sources, which exposes those applications and downstream users to potentially malicious files (e.g., objects that may be infected with malware, viruses, ransomware, trojan horses, etc). In particular, ingested AI models received from an untrusted third party source may include underlying AI model attributes that present abuse risks and can be used to trigger a security attack. Existing systems are typically unable to identify the likelihood that the underlying AI model attributes can cause security-related damage if executed by a primary computing system, making it difficult to assess the risks associated with an AI model.

Aspects of the present disclosure address the aforementioned problems and other technological challenges related to protecting a primary computing system (e.g., computing system hosting applications, services, underlying infrastructure, etc.) from security risks associated with ingesting one or more files implementing an AI model by determining security-related damage likelihood assessments associated with AI model attributes. As used herein, the AI model attributes may include any feature, aspect, component, variable, etc. of the AI model, including, for example, operators, instructions, parameters, and operation codes (OpCodes).

In some embodiments, the primary computing system employs a security risk damage likelihood assessment system which analyzes files associated with an AI model to be ingested by the primary computing system (e.g., ingested AI models received from one or more third-party sources which exposes applications and downstream users of the primary computing system to potentially malicious files. In an embodiment, the ingested AI models received from an untrusted third party source include underlying AI model attributes that present abuse risks and can be used to induce a security attack.

According to embodiments, the security risk damage likelihood assessment system identifies AI model attributes of an AI model and determines a likelihood of one or more AI model attributes causing damage to the primary computing system (herein the “damage likelihood”). For example, for each AI model attribute, the risk assessment system may assign a damage likelihood score or grade (herein the “damage likelihood grade”), such as “high” grade, a “medium” grade, or a “low” grade, to the particular AI model attribute.

According to an embodiment, the security risk damage likelihood assessment system performs a review of an initial evaluation of each AI model attribute of the AI model (also referred to as the “initial evaluation data”). According to embodiments, the initial evaluation data may be based on one or more factors corresponding to each AI model attribute. Example factors include a level of access of an AI model attribute to resources of the primary computing system, a potential for data manipulation associated with an AI model attribute, historical security-related incidents associated with an AI model attribute, etc.

In an embodiment, the security risk damage likelihood assessment system may employ a static code analysis to scan and identify implementations of the AI operators (e.g., AI operators identified in the initial evaluation data) and identify potentially dangerous functions or patterns that may indicate a higher damage likelihood.

In an embodiment, the security risk damage likelihood assessment system performs, based on the initial evaluation data, one or more tests in a testing environment to evaluate a behavior of the AI model attributes associated with the AI model under one or more test input sets or test plans. The security risk damage likelihood assessment system monitors and tracks one or more observed behaviors associated with the testing of the AI model attributes of the AI model. The observed behaviors can include unexpected system calls, resource usage data, output patterns, etc.

In an embodiment, the security risk damage likelihood assessment system determines a damage likelihood score (also referred to as a “damage likelihood assessment”) of the AI model based on the one or more observed behaviors associated with the one or more AI model attributes of the AI model. According to embodiments, the security risk damage likelihood assessment system may conduct one or more of the following analysis for use in determining the damage likelihood assessment for an AI model attribute: a static code analysis, a behavioral testing analysis, a historical incident correlation analysis, and/or a threat intelligence integration analysis.

The security risk damage likelihood assessment system can generate and manage a data store or library including historical security incident data relating to a set of AI model attributes (e.g., a mapping which associates respective AI model attributes with historical security incident data). The security risk damage likelihood assessment system correlates new AI model attributes with historical security incident data.

According to embodiments, the security risk damage likelihood assessment system can adjust a damage likelihood assessment associated with an AI model based on identified similarities to one or more other AI model attributes that were previously identified or marked as representing a security risk. In an embodiment, the security risk damage likelihood assessment system can monitor and collect security-related data (also referred to as “AI security data”) from one or more third-party sources (e.g., AI security research papers, common vulnerabilities and exposures (CVE) databases, technology forums, threat intelligence feeds, etc.). The security risk damage likelihood assessment system can use the AI security data (e.g., security attack vector data associated with specific AI model attributes) to update the damage likelihood assessment. For example, the security risk damage likelihood assessment system may identify, in the AI security data, a new vulnerability or attack vector associated with a first AI model attribute. The security risk damage likelihood assessment system may determine that the first AI model attribute is included in an ingested AI model or is similar to an AI model attribute of the ingested AI model and adjust or re-calculate the damage likelihood assessment based on the identification of the new vulnerability or attack vector.

According to embodiments, the security risk damage likelihood assessment system monitors the usage of AI model attributes of an ingested AI model in a production environment (e.g., during execution of the AI model by the primary computing system). The security risk damage likelihood assessment system can generate production usage data corresponding to the AI model and uses this data to adjust or update the corresponding damage likelihood assessment. The production usage data may include a frequency of use of an AI model attribute, resource consumption patterns associated with an AI model attribute, interactions with sensitive data or sensitive systems by an AI model attribute, etc. In an embodiment, the generated production usage data can be queried to identify security risk information associated with the AI model in the production environment. For example, the production usage data can be queried to identify one or more AI model attributes that are in use for a selected AI model developer, a selected AI model consumer, or a selected application developer.

According to embodiments, the security risk damage likelihood assessment system determines if the updated damage likelihood assessment associated with the AI model satisfies a condition. In an embodiment, the condition is satisfied if the updated damage likelihood assessment is greater than a threshold damage likelihood level. In response to the condition being satisfies, the security risk likelihood assessment system can generate an alert relating to the AI model and corresponding damage likelihood assessment. In an embodiment, the security risk damage likelihood assessment system executes, based on the alert, a remedial action with respect to the computing system.

According to embodiments, the security risk damage likelihood assessment system implements and trains a machine learning model to determine the damage likelihood assessment associated with an AI model based on observed AI model attribute characteristics and historical security risk data. The machine learning model may be used to generate and adjust the damage likelihood assessment based on the initial evaluation data, test environment observations, and production environment usage data.

Advantageously, the security risk damage likelihood assessment system implements a multi-faceted approach to determining and updating a security risk damage likelihood assessment for AI model attributes based on initial evaluation data, automated AI model attribute analysis, and production environment usage monitoring. The security risk damage likelihood assessment system determines a potential or likelihood for AI model attributes to cause damage or be used maliciously. In embodiments, the security risk damage likelihood assessment system employs analysis techniques (e.g., static code analysis, behavior-based testing, and historical incident correlation) to generate and update a damage likelihood assessment (e.g., a damage likelihood grade or score) associated with one or more operators of an AI model. The security risk damage likelihood assessment system is configured to update the damage likelihood scores through real-time monitoring, anomaly detection, and/or user feedback loops. This iterative assessment methodology effectively provides for a dynamic and comprehensive view of AI model operator damage likelihood that evolves with the threat landscape and actual production environment usage patterns.

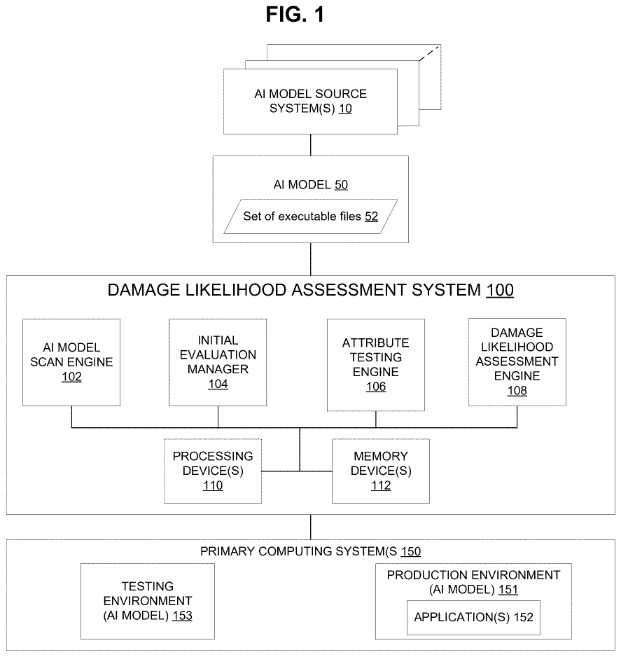

FIG. 1 is a block diagram of an example damage likelihood assessment system 100 communicatively coupled to one or more computing systems 10 associated with one or more AI models to be consumed in a production environment 151 by one or more applications 152 executed by one or more primary computing systems 150, according to one or more embodiments. According to an embodiment, the damage likelihood assessment system 100 ingests an AI model 50 including a set of executable files 52 from one or more of the source systems (herein “AI model source systems”) 10. In an embodiment, the AI model 50 may be uploaded for use by one or more applications 152 associated with one or more primary computing systems 150. According to embodiments, prior to use by the one or more applications 152, the damage likelihood assessment system 100 ingests the AI model 50 and performs damage likelihood assessment management, as described in detail.

According to embodiments, the damage likelihood assessment system 100 includes control logic (e.g., an AI model scan engine 102, an initial evaluation manager 104, a damage likelihood assessment engine 108, and an attribute testing engine 106) configured to manage the damage likelihood and security risks associated with the ingested AI model 50. According to embodiments, the damage likelihood assessment system 100 includes one or more processing devices 110 configured to execute instructions stored in one or more memory devices 112, the instructions for performing the operations and steps associated with the control logic of the damage likelihood assessment system 100, described in detail herein.

According to embodiments, the one or more processing device 110 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. According to embodiments, the one or more processing devices 110 can also be one or more special-purpose processing devices such as an application specific integrated circuit (ASIC), a field programmable gate array (FPGA), a digital signal processor (DSP), network processor, or the like.

According to embodiments, the one or more memory devices 112 includes an embedded memory configured to store instructions for performing various processes, operations, logic flows, and routines that control operation of the damage likelihood assessment system 100. According to embodiments, the one or more memory devices can include a main memory (e.g., read-only memory (ROM), flash memory, dynamic random access memory (DRAM) such as synchronous DRAM (SDRAM) or Rambus DRAM (RDRAM), etc.), a static memory (e.g., flash memory, static random access memory (SRAM), etc.), and a data storage system, which communicate with each other via a bus.

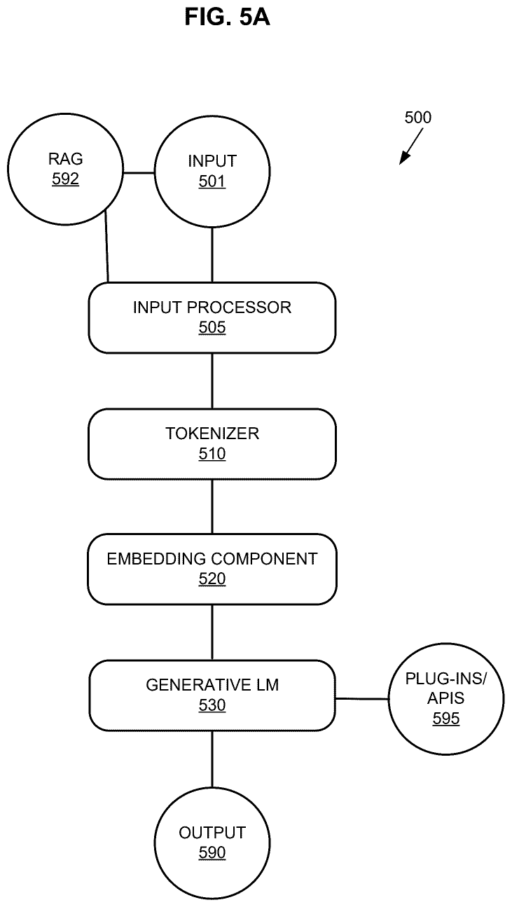

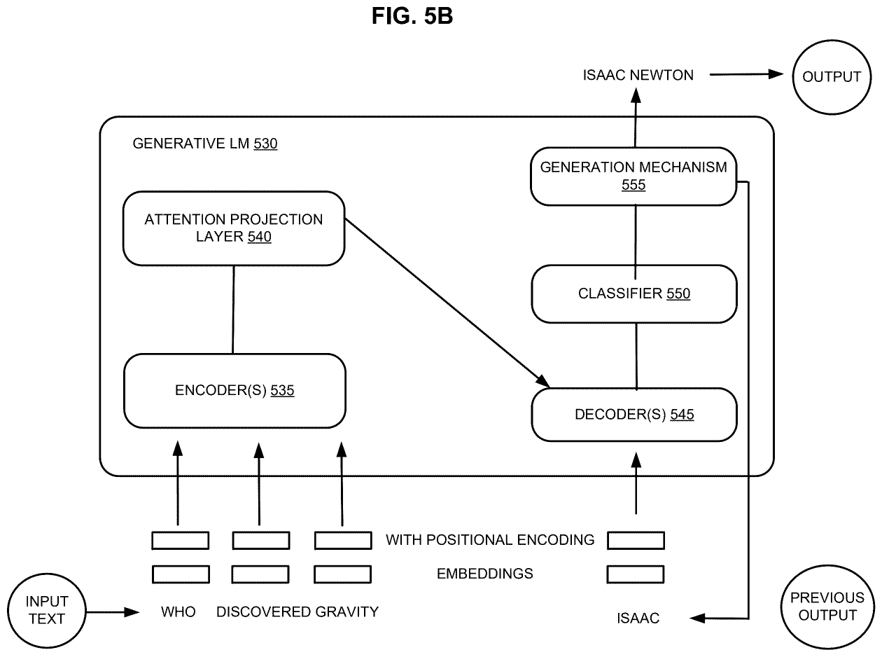

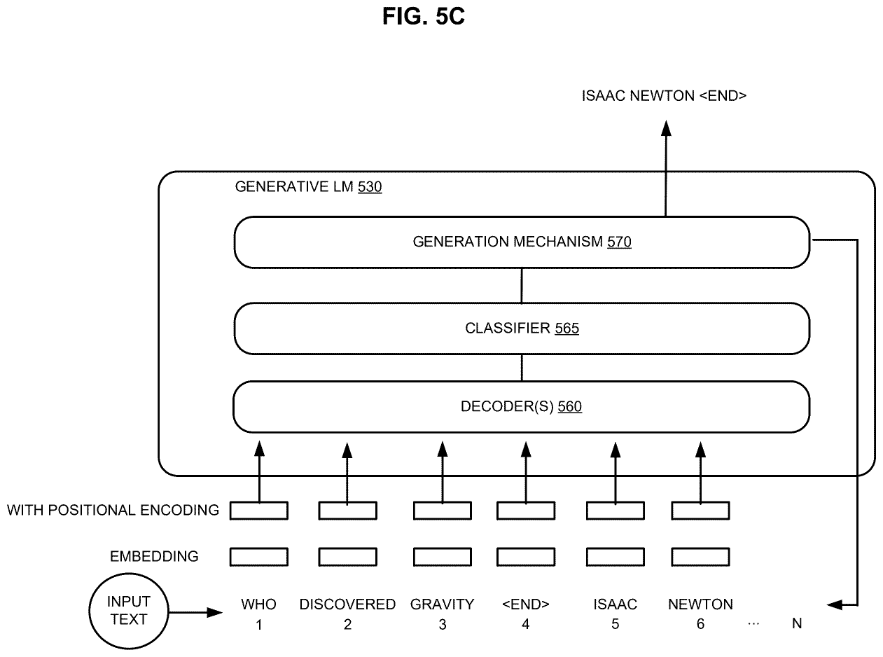

According to embodiments, the AI model 50 may automate tasks traditionally performed by humans including creating representation of artificial characters, e.g., digital avatars, game characters, chatbots, and/or the like. Example AI models include discriminative models and generative models. Discriminative AI models are trained to classify inputs by identifying patterns in training data (e.g., sounds, images, actions, face expressions, texts, and/or other data), such as presence of a particular type of an object within a training image or a particular word within a training speech or text or data. Generative AI models are trained to generate new data that is similar to human-created (e.g., texts) or naturally occurring (e.g., images) training data. Training can be supervised, self-supervised, unsupervised, reinforced, instructional fine-tuning, and/or the like. After successful training, deployed AI models are used to classify and/or generate new data. For example, generative language models—such as large language models (LLMs)—are capable of supporting conversations in a natural language, understanding speaker's intent and emotions, explaining complex topics, creating new texts upon receiving suitable prompts, providing advice regarding topics of interest to a user, processing image, audio, and/or other data types, and/or performing other functions. Further details relating to LLMs are described below with reference to FIGS. 5A-5C.

According to embodiments, the AI model 50 (e.g., a deep learning model, an LLM, a small language model (SLM), a vision language model (VLM), a multimodal language model (MMLM)), etc.) can include hundreds of millions or billions of learnable parameters (e.g., weights and biases of artificial neurons) and are trained using massive amounts of training data. Training of such complex models can be performed using distributed computing where multiple (e.g., tens or even hundreds of) computing nodes learn from different sets of training data in parallel. Individual computing nodes deployed in distributed training can include various processing units, such as central processing units (CPUs) and graphics processing units (GPUs). According to embodiments, the computing nodes may include some or all of one or more GPUs, CPUs, parallel processing units (PPUs), data processing units (DPUs), or accelerators, and/or other suitable processing devices capable of performing computing associated with the AI model 50.

According to embodiments, the AI model scan engine 102 of the damage likelihood assessment system 100 identifies the AI model 50 that has been provided (e.g., uploaded) for consumption by one or more of the applications 152. In an embodiment, the AI model scan engine 102 scans the AI model 50 to identify a set of one or more AI model attributes. For example, AI model scan engine 102 scans and parses a code set of one or more of the files 52 of the AI model 50 (e.g., ONNX-formatted model files) and identifies the set of AI model attributes (e.g., ONNX attributes) present in the AI model 50. Example AI model attributes include shapes, operators, inferences, etc. used to define the operations and functionality of the AI model 50. According to embodiments, the AI model scan engine 102 can identify standard AI model attributes (e.g., known or supported attributes) and custom AI model attributes (e.g., AI model attributes that are non-standard or created as a custom attribute by a model developer). In an embodiment, the AI model scan engine 102 may maintain a data structure storing information associated with the identified set of AI model attributes.

According to embodiments, the initial evaluation manager 104 processes initial evaluation data associated with each AI model attribute included in the AI model (e.g., the AI model attributes identified by the AI model scan engine 102). According to embodiments, the initial evaluation manager 104 may collect and store initial evaluation data that is based on one or more factors corresponding to each AI model attribute. Example factors include a level of access of an AI model attribute to resources of the primary computing system 150, a potential for data manipulation associated with an AI model attribute, historical security-related incidents associated with an AI model attribute, etc.

In an embodiment, the initial evaluation data may be collected by the initial evaluation manager 104 from one or more of a user-input (e.g., a security engineer providing evaluation information associated with one or more AI model attributes), one or more AI security-related data sources (e.g., from one or more third-party sources (e.g., AI security research papers, common vulnerabilities and exposures (CVE) databases, AI-specific vulnerability databases (e.g., AI Incident Database), technology forums, etc.).

According to embodiments, the initial evaluation data may include attribute-specific assessment information including an evaluation of the ability of an attribute (e.g., a dumpRefit attribute) to modify AI model parameters or variables, an assessment of the potential for the AI model attribute (e.g., a dumpOutput attribute) to cause a leak of sensitive information, an assessment of a likelihood of the AI model attribute (e.g., a dumpProfile attribute) exposing system configuration details, an examination of a potential for the AI model attribute (e.g., a RandomNormal, RandomNormalLike, RandomUniform, and/or RandomUniformLike attribute) to introduce malicious randomness, an assessment as to whether the AI model attribute (e.g., a Range attribute) causes resource exhaustion, an assessment as to the potential for the AI model attribute (e.g., a minShapes attribute) to manipulate model behavior through shape modifications.

In an embodiment, the attribute testing engine 106 performs behavioral testing relating to the AI model attributes. In an embodiment, the attribute testing engine 106 performs one or more tests to determine one or more observed behaviors associated with an AI model. In an embodiment, the attribute testing engine 106 performs the one or more tests in a testing environment 153 associated with the primary computing system 150.

According to embodiments, the attribute testing engine 106 performs the one or more tests to identify and evaluate observed behaviors associated with a target AI model attribute. The observed behaviors may include resource usage patterns (e.g., CPU utilization spikes, memory consumption patterns, I/O operation frequencies, network activity patterns, etc.), system interaction behaviors (e.g., unexpected system calls, access attempt patterns, data manipulation activities, AP interaction frequencies, etc.), and/or output pattern behaviors (e.g., response pattern anomalies, data leakage indicators, error rate pattens, output consistency measures, etc.).

According to embodiments, the attribute testing engine 106 generates test data (e.g., test results) associated with the one or more tests relating to the target AI model attribute operating in the testing environment 153. The test data may include information associated with one or more of the observed behaviors (e.g., resource usage patterns, system interaction behaviors, output pattern behaviors). According to embodiments, the one or more tests generated and executed to test the target AI model attribute behavior under one or more input or testing conditions. In an embodiment, the attribute testing engine 106 can configure the one or more tests based at least in part on the initial evaluation data. In an embodiment, the attribute testing engine 106 provides the test data (e.g., the test result data) to the damage likelihood assessment engine 108 for use in generating a damage likelihood grade or score for each AI model attribute, as described in greater detail below.

According to embodiments, the attribute testing engine 106 can employ an automated testing framework including a set of one or more tests configured to probe target AI attributes deployed in the production environment 151 of the primary computing system 150 operators to identify potential vulnerabilities. The production environment tests can be executed periodically against one or more AI model attributes deployed in the production environment 151 and the test results can be used to adjust or update the damage likelihood scores, as described in detail below.

According to embodiments, the damage likelihood assessment engine 108 analyzes each of the AI model attributes and determines a likelihood of one or more AI model attributes causing damage to the primary computing system (the “damage likelihood”). For example, for each AI model attribute, the risk assessment system may assign a damage likelihood grade (the “damage likelihood grade”), such as “high” grade, a “medium” grade, or a “low” grade, to the particular AI model attribute. In an embodiment, a high damage likelihood grade may indicate that a particular AI model attribute represents a high probability of being exploited for malicious purposes. In an embodiment, a medium damage likelihood grade may indicate that a particular AI model attribute has a potential for exploitation, but with one or more barriers or protections against such damage. In an embodiment, a low damage likelihood grade may indicate that a particular AI model attribute is unlikely (e.g., below a threshold probability) to be exploited or has minimal potential for causing damage.

According to embodiments, the damage likelihood assessment engine 108 may execute one or more of the following processes to determine or calculate the damage likelihood assessment for an AI model attribute: a static code analysis, a historical incident correlation analysis, a threat intelligence integration analysis, and/or a behavioral data analysis based on test data generated by the attribute testing engine 106.

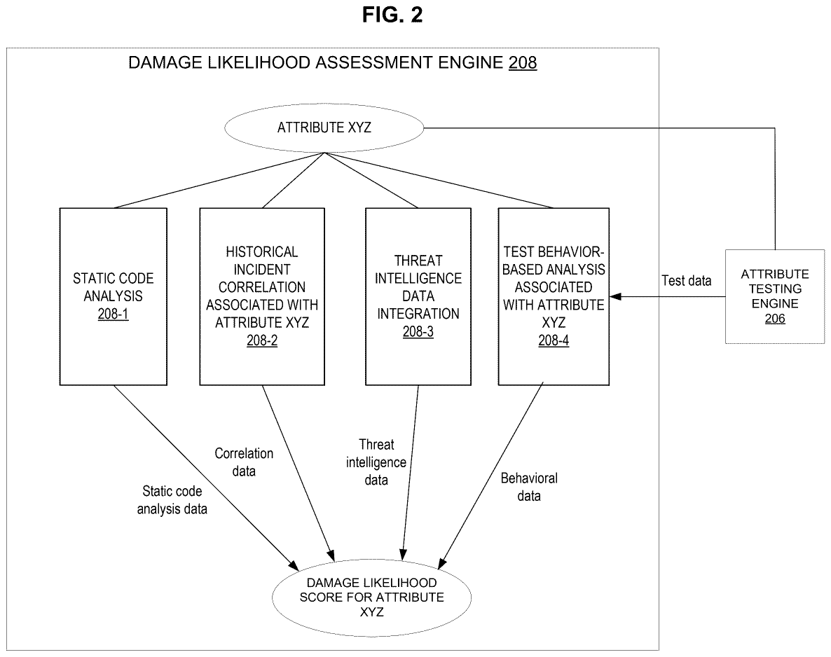

FIG. 2 illustrates an example damage likelihood assessment engine 208 configured to generate a damage likelihood grade for a target AI model attribute (Attribute XYZ) associated with an AI model to be executed by a primary computing system (e.g., primary computing system 150 of FIG. 1), according to embodiments of the present disclosure. As shown in FIG. 2, the damage likelihood assessment engine 208 is configured to perform one or more of: a static code analysis associated with Attribute XYZ 208-1, a historical incident correlation associated with Attribute XYZ 208-2, a threat intelligence data integration associated with Attribute XYZ 208-3, and a test behavior-based analysis associated with Attribute XYZ 208-4, as described in detail herein.

In an embodiment, the damage likelihood assessment engine 208 may implement automated code analysis 208-1 to scan the AI model (e.g., the one or more files of the AI model) for a set of AI model attributes that represent functions or patterns indicative of a higher likelihood of damage to the primary computing system 150 and generate static code analysis data. In an embodiment, the static code analysis can be performed using information identified by the initial evaluation manager 104 (e.g., one or more flagged or previously identified AI model attributes that represent a damage likelihood risk) or based on AI security related data aggregated from one or more sources. In an embodiment, the damage likelihood assessment engine 108, 208 may maintain and manage a database of previously-identified or historical security related incidents mapped to or associated with one or more AI model attributes. In an embodiment, the static code analysis data can include historical security-related data associated with an identified AI model attribute identified during the static code analysis.

As shown in FIG. 2, according to embodiments, the damage likelihood assessment engine 208 may execute a correlation process to generate correlation data associated with an identified AI model attribute (herein a “first AI model attribute” or “identified AI model attribute”) and a new or previously unidentified AI model attribute (i.e., a second AI model attribute or “unidentified AI attribute”). Advantageously, based on the correlation process, correlation data including a damage likelihood assessment or properties associated with the identified AI attribute can be generated and used to determine a damage likelihood assessment for the unidentified AI model attribute. For example, the correlation data may be based on the correlation or mapping between the two AI model attributes (e.g., a correlation between Attribute XYZ and an identified attribute having established damage likelihood characteristics) and may be used in determining a damage likelihood grade of Attribute XYZ.

According to embodiments, the damage likelihood assessment engine 208 may perform a correlation process 208-2 to determine if a new AI model attribute (e.g., an unidentified AI model attribute associated with an AI model under analysis of the damage likelihood assessment system 100) is correlated to a known AI model attribute identified in the historical incident data. In an embodiment, the damage likelihood assessment engine 208 analyzes an unidentified AI model attribute and performs one or more of the following operations or processes to identify correlations between AI model attributes: attribute signature matching, behavioral pattern correlation, contextual analysis, and/or historical impact mapping. Advantageously, the correlation process executed by the damage likelihood assessment engine 108 is dynamic and continuously updated as new security incident data becomes available, ensuring that the damage likelihood assessment evolves with emerging threats.

In an embodiment, the correlation process 208-2 can include attribute signature mapping in which the damage likelihood assessment engine 208 examines function signatures and patterns, operational characteristics, resource access patterns, and/or data manipulation methods associated with the unidentified AI model attributes and compares the attribute signature mapping data to the historical incident data. For example, if a new or unidentified AI model attribute exhibits similar patterns to a historically problematic identified AI model attribute in terms of memory access or API usage patterns, the damage likelihood assessment engine 108 may use this signature mapping as a factor in determining if there is a correlation between the unidentified AI model attribute and the identified AI model attribute.

In an embodiment, the correlation process 208-2 can include behavioral pattern analysis in which the damage likelihood assessment engine 208 compares resource utilization signatures, system call patterns, input-output relationships, and/or error handling characteristics of an unidentified AI model attribute with the historical incident data. For example, when a new or unidentified AI model attribute exhibits behavior patterns similar to those associated with historical security incidents associated with an identified AI model attribute, the damage likelihood assessment engine 208 may use the behavioral pattern matching as a factor in determining if there is a correlation between the unidentified AI model attribute and the identified AI model attribute.

In an embodiment, the correlation process 208-2 can include contextual analysis in which the damage likelihood assessment engine 208 examines deployment context similarities, usage pattern matches, security boundary interactions, and/or data access patterns of an unidentified AI model attribute as compared to the historical incident data. For example, if a new or unidentified AI model attribute operates in a similar context (e.g., the handling of sensitive data) to a historically vulnerable identified AI model attribute, the damage likelihood assessment engine 208 can use this as a factor in determining if there is a correlation between the unidentified AI model attribute and the identified AI model attribute.

In an embodiment, the correlation process 208-2 can include historical impact mapping in which the damage likelihood assessment engine 208 maintains a database that maps previous security incidents, associated attribute characteristics, impact severity levels, and/or exploitation methods associated with an unidentified AI model attribute with the historical incident data. The engine 208 may use the historical impact mapping data to determine as a factoring in identifying a correlation between an unidentified AI model attribute and an identified AI model attribute associated with the historical incident data.

According to embodiments, the damage likelihood assessment engine 208 may generate correlation data including data related to one or more of the above-described correlation methods (e.g., attribute signature matching, behavioral pattern correlation, contextual analysis, and historical impact mapping) as part of the correlation method 208-2.

As shown in FIG. 2, in an embodiment, the damage likelihood assessment engine 208 may perform threat intelligence data integration 208-3 to generate threat intelligence data associated with an AI model attribute (e.g., Attribute XYZ) for use in generating a damage likelihood grade for the AI model attribute. According to embodiments, the damage likelihood assessment engine 208 may have access to and collect security-related data (also referred to as “AI security data”) from one or more third-party sources (e.g., AI security research papers, common vulnerabilities and exposures (CVE) databases, technology forums, threat intelligence feeds, etc.). The AI security data may include one or more threat intelligence feeds that focus on AI model security. According to embodiments, as shown in FIG. 2, the damage likelihood assessment engine 208 can perform threat intelligence data integration 208-3 to integrate the collected AI security data and generate a data store or library of threat intelligence data (e.g., security risk scenarios associated with one or more AI models). In an embodiment, the threat intelligence data integration 208-3 can include the cross-referencing or mapping of the security risk scenarios that are identified in the aggregated and collected security-related data to one or more specific AI model attributes employed by a target AI model. For example, in the threat intelligence data integration 208-3, the damage likelihood assessment engine 208 can generate threat intelligence data including a mapping or association between a first set of security risk scenarios identified in the collected AI model data and the target AI model attribute (e.g., Attribute XYZ). Advantageously, the threat intelligence data integration 208-3 may be performed automatically to discover new AI related data and new security risk scenarios (e.g., security risk scenarios associated with the target AI model attribute or a similar AI model attribute) that can be integrated or mapped to a target AI model attribute for use in updating the damage likelihood grade or score for the target AI model attribute.

As shown in FIG. 2, in an embodiment, the damage likelihood assessment engine 208 may perform a test behavior-based analysis 208-4 of the test data generated by the attribute testing engine 206, as described above. According to embodiments, the test data may include information associated with one or more observed behaviors (e.g., resource usage patterns, system interaction behaviors, output pattern behaviors) associated with the testing of the Attribute XYZ in a testing environment associated with the primary computing system (e.g., testing environment 153 of the primary computing system 150 of FIG. 1). According to embodiments, the test data is generated (e.g., by the attribute testing engine 106, 206) by the execution of one or more tests configured to test the behavior of Attribute XYZ under one or more input or testing conditions within the testing environment. In an embodiment, the attribute testing engine 106, 206 can configure the one or more tests based at least in part on the initial evaluation data associated with the Attribute XYZ and/or the target AI model. As shown in FIG. 2, the attribute testing engine 206 provides the test data (e.g., the test result data) to the damage likelihood assessment engine 208 for use in the execution of test behavior-based analysis 208-4. According to embodiments, the damage likelihood assessment engine 208 performs the test behavior-based analysis 208-4 to process the test data to identify behavioral data associated with Attribute XYZ for use in generating a damage likelihood grade for Attribute XYZ. In an embodiment, the damage likelihood assessment engine 208 generates behavioral data associated with Attribute XYZ that includes one or more of resource usage patterns, system interaction behaviors, and output pattern analysis identified in response to the testing of Attribute XYZ by the engine 206.

According to embodiments, the damage likelihood assessment engine 108, 208 generates a damage likelihood score (DL) associated with a target AI model attribute (e.g., Attribute XYZ of FIG. 2). According to an embodiment, the damage likelihood score can be determined in accordance with the following example expression:

DL=(Wbs×Bs)+(Whs×Hs)+(Wrs×Rs);

where Bs represents a behavioral score (e.g., in a range of 0-1) generated based on the behavioral data generated by the test behavior-based analysis (e.g., 208-4 of FIG. 2), where Hs represents a historical incident score (e.g. in a range of 0-1) generated based on the correlation data generated by the historical incident correlation (e.g., 208-2 of FIG. 2), where Rs represents a resource impact score (e.g., in a range of 0-1) generated based on a review to determine if the target AI model contains one or more specific attributes (e.g., operators or opCodes) which can be leveraged to realize a resource exhaustion attack (also referred to as “resource exhaustion-related attributes”), and where Wbs, Whs, Wrs represent respective weights associated with the behavioral score (Bs), the historical incident score (Hs), and the resource impact score (Rs). According to embodiments, the weights (Wbs, Whs, and Wrs) are configurable based on a target deployment context (e.g., a production environment 151 and/or or more applications 152 of the primary computing system 150 of FIG. 1 in which the target AI model including the target AI model attribute is to be deployed). According to embodiments, Bs may be based at least in part on data generated as a result of the execution of the static code analysis 208-1. According to embodiments, Hs may be based at least in part on data generated as a result of the threat intelligence data integration 208-3.

According to embodiments, Rs can be determined by identifying a set of one or more resource exhaustion-related attributes that are present in the target AI model. Example resource exhaustion-related attributes include minShapes and custom model attributes (e.g., operators) such as excludeLeanRuntime, useCudaGraph, optShapes, minShapesCalib, maxShapes, optShapesCalib, maxShapesCalib, inputIOFormats, outputIOFormats, Workspace, profilingVerbosity, and minTiming. According to embodiments, the identified set includes one or more resource exhaustion-related attributes that are inter-dependent on another model attribute such that those resource exhaustion-related attributes can cause damage if the other model attribute is present. In an embodiment, the Rs can be calculated using an expression such as, for example: [total number of model attributes present in the target AI model] divided by [total number of resource exhaustion-related attributes present in the target AI model].

According to embodiments, the damage likelihood assessment engine 108, 208 can generate a damage likelihood classification or category associated with the target AI model attribute (e.g., Attribute XYZ in FIG. 2) based on the calculated damage likelihood score (DL). For example, the damage likelihood assessment engine 108, 208 can map or classify a risk level associated with the target AI model attribute based on the final DL as follows:

High Risk Category: DL>0.7

Medium Risk Category: 0.4≤DL≤0.7

Low Risk Category: DL<0.4

Advantageously, the calculated damage likelihood score and corresponding risk level category generated by the damage likelihood assessment engine 108, 208 provides a standardized way to quantify the risk level based on one or more of observed behaviors during testing.

According to embodiments, the damage likelihood assessment engine 108, 208 can adjust a damage likelihood assessment associated with an AI model based on identified similarities to one or more other AI model attributes that were previously identified or marked as representing a security risk. In an embodiment, the security risk damage likelihood assessment system can monitor and collect AI security data from one or more third-party sources (e.g., AI security research papers, common vulnerabilities and exposures (CVE) databases, technology forums, threat intelligence feeds, etc.). The security risk damage likelihood assessment system can use the AI security data (e.g., security attack vector data associated with specific AI model attributes) to identify similarities between AI model attributes (e.g., a first AI model attribute identified in the AI security data and a second AI model attribute of an AI model deployed on the primary computing system 150, for purposes of updating the damage likelihood assessment associated with the second AI model attribute.

According to an embodiment, the damage likelihood assessment engine 108, 208 can perform a damage likelihood score adjustment process based on the identification and comparison of similar AI attributes. In an embodiment, the damage likelihood assessment engine 108, 208 determines a similarity (e.g., a similarity score) between a first AI model attributes (identified in the AI security data) and a second AI model attribute associated with an AI model deployed by the primary computing system 150. In an embodiment, a total similarity score (TSS) may be determined based on one or more of a structural similarity score (Sss), a behavioral similarity score (Bss), and a historical risk score (Hrs). In an embodiment, the structural similarity score (Sss) may be determined based on one or more of attribute type matching, a function signature comparison, parameter patterns, and resource access methods associated with the first AI model attribute and the second AI model attribute. In an embodiment, the behavioral similarity score (Bss) may be determined based on one or more of runtime behavior patterns, resource utilization profiles, system interaction patterns, and error handling methods associated with the first AI model attribute and the second AI model attribute. In an embodiment, the historical risk score (Hss) may be determined based on one or more of a previous incident correlation (e.g., as generated in operation 208-2 of FIG. 2), known vulnerability matches, exploitation histories, and security incident patterns associated with the first AI model attribute and the second AI model attribute.

In an embodiment, the total similarity score (TSS) may be calculated by the damage likelihood assessment engine 108, 208 in accordance with the following example expression:

Tss=(Ws×Ss)+(Wb×Bs)+(Wh×Hs);

where Ws represents a structural similarity weight (e.g., in a range of 0 to 1, such as 0.3), where Wb represents a behavioral similarity weight (e.g., in a range of 0 to 1, such as 0.4), where Wh represents a historical similarity weight (e.g., in a range of 0 to 1, such as 0.3), where the weights add up to 1.0.

According to embodiments, the damage likelihood assessment engine 108, 208 may use the total similarity score (TSS) to determine and apply adjustments to a damage likelihood score associated with a target AI model attribute. In an embodiment, an adjusted damage likelihood score (DL_adjusted) can be determined in accordance with the following example expression:

DL_adjusted=DL_current+(TSS×Historical_Risk_Factor)

where DL_current represents a current damage likelihood score, and where the Historical_Risk_Factor represents a risk level of one or more similar historical AI model attributes (e.g., in a range of 0.1 to 1.0).

According to embodiments, the damage likelihood assessment engine 108, 208 can classify the adjusted damage likelihood score (DL_adjusted) as follows:

High Risk Category: DL_adjusted>0.7

Medium Risk Category: 0.4≤DL_adjusted≤0.7

Low Risk Category: DL_adjusted<0.4

According to embodiments, the damage likelihood assessment engine 108, 208 can adjust or re-calculate a damage likelihood score associated with a target AI model attribute (e.g., Attribute XYZ of FIG. 2) based on the identification of a new or previously unidentified security risk scenario (e.g., a new vulnerability or attack vector). The damage likelihood assessment engine 108, 208 can use the AI security data (e.g., security risk scenario data) to identify the new vulnerability or security risk scenario associated with a first AI model attribute. The damage likelihood assessment engine 108, 208 may determine that the first AI model attribute is included in an ingested AI model (e.g., AI model 50) or is similar to an AI model attribute of the ingested AI model and adjust or re-calculate the damage likelihood assessment based on the identification of the new vulnerability or security risk scenario.

According to embodiments, the damage likelihood assessment engine 108, 208 performs an initial evaluation of a newly discovered or identified security risk scenario to identify a base risk impact (RI). In an embodiment, the base risk impact (RI) is determined using the following example expression:

RI=(Severity×Exploitability);

where the Severity represents an impact of the security risk scenario or vulnerability if exploited (e.g., on a scale of 0 to 1), and where the Exploitability represents an ease or difficultly associated with exploiting the security risk scenario or vulnerability.

In an embodiment, the damage likelihood assessment engine 108, 208 may determine an attribute correlation factor (ACF) to determine a correlation between an AI model attribute associated with the newly identified security risk scenario and a target AI model attribute (i.e., a model attribute of an AI model 50 deployed by the primary computing system 150). In an embodiment, the attribute correlation factor (ACF) is determined in accordance with the following example expression:

ACF=(Match_Score×Usage_Factor);

where the Match_Score represents a measure of similarity between the model attribute associated with the newly identified security risk scenario and the target AI model attribute (e.g., a value in a range of 0 to 1), and where the Usage_Factor represents a frequency associated with the use of the target AI model attribute in the AI model 50.

According to embodiments, the damage likelihood assessment engine 108, 208 can determine an adjusted damage likelihood score associated with the target AI model attribute. In an embodiment, the adjusted damage likelihood score (DL_Adjusted) is determined in accordance with the following example expression:

DL_Adjusted=Min(1.0, Current_DL+(RI×ACF)).

In an example, the damage likelihood assessment engine 108, 208 may identify a deployed AI model (e.g., AI model 50 of FIG. 1) using a text processing operator (i.e., the target AI model attribute). The target AI model attribute may have a current (or initial) damage likelihood score of 0.5 (i.e., a Medium risk score) and a current usage level of 0.9 (i.e., a high usage level). In this example, the damage likelihood assessment engine 108, 208 may identify a new security risk scenario (e.g., a prompt injection vulnerability) having a Severity level of 0.8 (i.e., a High impact vulnerability), an Exploitability level of 0.7 (i.e., indicating the attribute is relatively easy to exploit), and a Match_Score of 0.9 (i.e., the target AI model attribute is very similar to an attribute affected by the new security risk scenario. In this example, the damage likelihood assessment engine 108, 208 may calculate an adjusted damage likelihood score (DL_Adjusted), as follows:

RI=0.8×0.7=0.56;

ACF=0.9×0.9=0.81; and

DL_adjusted=Min(1.0, 0.5+(0.56×0.81))=0.95

In this example, the damage likelihood assessment engine 108, 208 determines that the damage likelihood score for the target AI model attribute increases from an original score of 0.5 (Medium risk level) to an adjusted score of 0.95 (High risk level). In an embodiment, in response to the adjustment of the damage likelihood score, the damage likelihood assessment engine 108, 208 can cause the generation of a high-risk alert and generate one or more remediation recommendations.

As shown in FIG. 1, the damage likelihood assessment system 100 monitors the usage of AI model attributes of an ingested AI model 50 as deployed in a production environment 151 (i.e., during execution of the AI model by the primary computing system 150). The damage likelihood assessment engine 108, 208 can generate production usage data corresponding to the AI model and uses this data to adjust or update the corresponding damage likelihood score. The production usage data may include a frequency of use of an AI model attribute, resource consumption patterns associated with an AI model attribute, interactions with sensitive data or sensitive systems by an AI model attribute, etc. In an embodiment, the generated production usage data can be queried to identify security risk information associated with the AI model in the production environment 151. For example, the production usage data can be queried to identify one or more AI model attributes that are in use for a selected AI model developer, a selected AI model consumer, or a selected application developer.

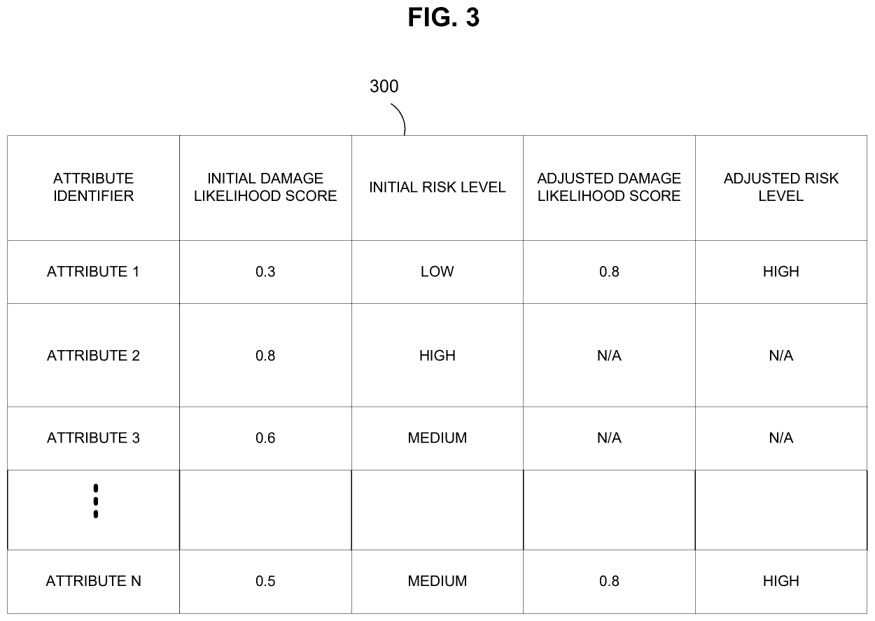

FIG. 3 illustrates an example data structure 300 including information generated by the damage likelihood assessment system 100, according to embodiments. As shown, the data structure 300 includes damage likelihood assessment data associated with a set of AI model attributes (e.g., Attribute 1, Attribute 2, Attribute 3 . . . Attribute N) of an AI model ingested by a primary computing system (e.g., AI model 50 ingested by the primary computing system 150 of FIG. 1). Each of the AI model attributes is associated with an initial damage likelihood score and initial risk level category generated by the damage likelihood assessment system 100 at a first time, as described above in detail. For example, Attribute 1 is associated with an initial damage likelihood score of 0.3 and a Low risk level, Attribute 2 is associated with an initial damage likelihood score of 0.8 and a High risk level, Attribute 3 is associated with an initial damage likelihood score of 0.6 and a Medium risk level, and Attribute N is associated with an initial damage likelihood score of 0.5 and a Medium risk level.

In the example shown in FIG. 3, at a second time, the damage likelihood assessment system 100 generates an adjusted damage likelihood score associated with Attribute 1 and Attribute N, in accordance with the adjustment processes described in detail above. As shown, the adjusted damage likelihood score for Attributes 1 and N cause the re-classification of those AI model attributes from an initial risk level to an adjusted risk level in the “High” category. I

According to embodiments, the damage likelihood assessment system 100 determines if the adjusted or updated damage likelihood score associated with the target AI model satisfies a condition. In an embodiment, the condition is satisfied if the adjusted or updated damage likelihood score is greater than a threshold damage likelihood level. In response to the condition being satisfies, the damage likelihood assessment system 100 generates an alert relating to the AI model 50 and corresponding damage likelihood assessment. In the example shown in FIG. 3, the damage likelihood assessment system 100 may generate an alert in connection with Attribute 2 based on the initial damage likelihood score (e.g., at the first time) and alerts with respect to Attributes 1 and N based on the adjusted damage likelihood scores (e.g., at the second time).

In an embodiment, the damage likelihood assessment system 100 can execute one or more remedial actions based on a damage likelihood score and risk level associated with a target AI model attribute. According to embodiments, in response to determining a target AI model attribute of an AI model has a damage likelihood score indicating a high risk level, the damage likelihood assessment system 100 can cause one or more high damage likelihood remedial actions. Example high damage likelihood remedial actions include the initiation of an immediate protection measure, such as an immediate AI model isolation in a restricted execution environment, a temporary suspension of AI model API access, enhanced monitoring and logging of all AI model interactions, and access restriction to sensitive data and resources.

In an embodiment, the example high damage likelihood remedial actions can include the initiation of one or more model-specific remediations (e.g., the implementation of targeted fixes based on the identified security risk scenarios associated with the target AI model attribute. In an example, for prompt injection risks, the damage likelihood assessment system 100 can initiate one or more of the following example targeted fixes: deploying enhanced input validation filters, implementing stricter prompt boundaries, adding additional context verification layers, and enhancing output sanitization. In an example, for resource exploitation risks, the damage likelihood assessment system 100 can initiate one or more of the following example targeted fixes: implementing stricter resource usage limits, deploying adaptive rate limiting, add resource consumption monitoring, and enforce stricter access controls.

According to embodiments, the damage likelihood assessment system 100 can implement one or more remedial actions relating to architectural safeguards in response to the identification of an AI model having a damage likelihood score indicating a high risk level. Example architectural safeguards can include implementing additional security boundaries, enhancing authentication mechanisms, deploying intrusion detection systems, adding audit logging systems.

According to embodiments, the damage likelihood assessment system 100 can implement one or more operational adjustments in response to the identification of an AI model having a damage likelihood score indicating a high risk level. Example operational adjustments can include triggering mandatory security reviews, enhancing monitoring protocols, updating access control policies, and modifying deployment procedures.

According to embodiments, the damage likelihood assessment system 100 can implement one or more long-term protection measures in response to the identification of an AI model having a damage likelihood score indicating a high risk level. Example long-term protection measures can include continuous vulnerability scanning, regular security assessment schedules, updated security training requirements, and enhanced documentation requirements.

According to embodiments, each remedial action initiated by the damage likelihood assessment system 100 can be automatically triggered based on risk level, documented for audit purposes, monitored for effectiveness, and adjusted based on outcomes.

According to embodiments, the damage likelihood assessment system 100 can monitor usage of a target AI attribute in the product environment 151 of the primary computing system 150. The real-time monitoring of operator usage in the production environment 151 enables the damage likelihood assessment system 100 to response to queries associated with the target AI model attribute. For example, the damage likelihood assessment system 100 can receive and respond to a query such as “Can you tell me which Operators are in use for any CSP/Model developer or model consumers/or AI Application developers?”

The damage likelihood assessment system 100 can further track metrics associated with a target AI attribute. Example metrics that can be tracked include a frequency of use, resource consumption patterns, and interaction with sensitive data or systems. In an embodiment, the damage likelihood assessment system 100 can adjust damage likelihood scores based on observed behavior in real-world scenarios, as described in detail above.

According to embodiments, the damage likelihood assessment system 100 can develop and employ one or more machine learning models to detect anomalous behavior of a target AI model attribute in the production environment 151. For example, the damage likelihood assessment system 100 train models on normal usage patterns and flags deviations from the normal usage patterns. In an embodiment, the damage likelihood assessment system 100 can adjust (e.g., increase) damage likelihood scores for a target AI model attribute that exhibits unexpected behavior.

The damage likelihood assessment system 100 may include a user feedback loop to enable a user (e.g., security researchers, model developers, etc.) to report potential misuse of a target AI model attribute. The damage likelihood assessment system 100 can create a workflow to review and incorporate the user feedback into the damage likelihood score generation performed by damage likelihood assessment engine 108, 208.

According to embodiments, the security risk damage likelihood assessment system implements and trains a machine learning model to determine the damage likelihood assessment associated with an AI model based on observed AI model attribute characteristics and historical security risk data. The machine learning model may be used to generate and adjust the damage likelihood assessment based on the initial evaluation data, test environment observations, and production environment usage data.

Advantageously, the damage likelihood assessment system 100 develops and continuously train a machine learning model to predict likelihood based on operator characteristics and historical data and use this model to cross-check and refine human and rule-based assessments.

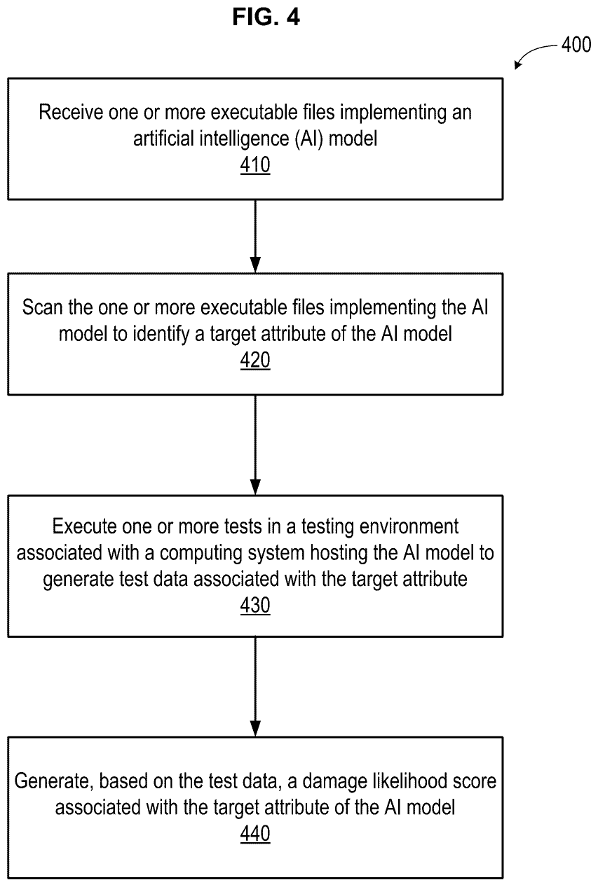

FIG. 4 is a flow diagram of an example method 400 related to generating a data likelihood score associated with a target AI model attribute of an AI model ingested for use by one or more applications executed by a computing system (e.g., primary computing system 150 of FIG. 1), in accordance with at least some embodiments. According to embodiments, the method 400 may be performed by control logic (e.g., damage likelihood assessment system 100 of FIG. 1). Method 400 may be performed by the control logic associated with one or more processing units (e.g., CPUs and/or GPUs), which may include (or communicate with) one or more memory devices. Various operations of method 400 may be performed in a different order compared with the order shown in FIG. 4. Some operations of the methods may be performed concurrently with other operations. In at least one embodiment, one or more operations shown in FIG. 4 may not always be performed.

At block 410, control logic (e.g., damage likelihood assessment system 100 of FIG. 1) receives one or more executable files implementing an artificial intelligence (AI) model. According to embodiments, the one or more executable files implementing the AI model may be received from a third party source system (e.g., an untrusted third party computing system). In an embodiment, the one or more executable files implementing the AI model are to be used or executed by one or more applications or users of a computing system (e.g., a primary computing system).

At block 420, control logic scans the one or more executable files implementing the AI model to identify a target attribute of the AI model. According to embodiments, the target attribute of the AI model may include one or more operators, inferences, shapes, instructions, parameters, OpCodes, etc. In an embodiment, the control logic scans the code of the one or more executable files to identify or extract the target attribute.

At block 430, control logic execute one or more tests in a testing environment associated with a computing system hosting the AI model to generate test data associated with the target attribute. In an embodiment, the one or more tests may include one or more behavioral tests configured to test the behavior of the target AI attribute in the testing environment. According to embodiments, the one or more tests may generate test data relating to resource usage patterns, system interaction behaviors, and output pattern analysis, as described in greater detail with reference to FIGS. 1 and 2.

At operation 440, control logic generates, based on the test data, a damage likelihood score associated with the target attribute of the AI model. According to embodiments, the damage likelihood score can be used to category a risk level associated with the target attribute (e.g., a High risk level, a Medium risk level, or a Low risk level), as described in detail above. In an embodiment, the damage likelihood score can be determined based on the test data in combination with one or more additional analysis (e.g., static code analysis, historical incident correlation analysis, and threat intelligence integration analysis), as described in detail above with reference to FIG. 2.

The systems and methods described herein may be used for a variety of purposes, by way of example and without limitation, to assess the risks associated with AI models used, for example, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as Open-USD, and/or other data types), systems implemented at least partially using cloud computing resources, and/or other types of systems.

In at least some embodiments, language models, such as large language models (LLMs) and/or other types of generative artificial intelligence (AI) may be implemented. These models may be capable of understanding, summarizing, translating, and/or otherwise generating text (e.g., natural language text, code, etc.), images, video, computer aided design (CAD) assets, omniverse and/or metaverse file information (e.g., in USD format), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/etc. may be implemented for summarizing textual data, analyzing and extracting insights from data (e.g., textual, image, video, etc.), and generating new text/image/video/etc. in user-specified styles, tones, and/or formats. The LLMs of the present disclosure may be used exclusively for text processing, in embodiments, whereas in other embodiments, multimodal LLMs may be implemented to accept, understand, and/or generate text along with other types of content like images, audio, and/or video. For example, vision language models (VLMs), or more generally multimodal language models, may be implemented to accept image, video, audio, textual, 3D design (e.g., CAD), and/or other inputs data types and/or to generate or output image, video, audio, textual, 3D design, and/or other output data types.

Various types of LLM/VLM/etc. architectures may be implemented in various embodiments. For example, different architectures may be implemented that use different techniques for understanding and generating outputs—such as text, audio, video, image, etc. In some embodiments, LLM architectures such as recurrent neural networks (RNNs) or long short-term memory networks (LSTMs) may be used, while in other embodiments transformer architectures—such as those that rely on self-attention mechanisms—may be used to understand and recognize relationships between words or tokens. One or more generative processing pipelines that include LLMs may also include one or more diffusion block(s) (e.g., denoisers). The language models of the present disclosure may include encoder and/or decoder block(s). For example, discriminative or encoder-only LLMs like BERT (Bidirectional Encoder Representations from Transformers) may be implemented for tasks that involve language comprehension such as classification, sentiment analysis, question answering, and named entity recognition. As another example, generative or decoder-only LLMs like GPT (Generative Pretrained Transformer) may be implemented for tasks that involve language and content generation such as text completion, story generation, and dialogue generation. LLMs that include both encoder and decoder components like T5 (Text-to-Text Transformer) may be implemented to understand and generate content, such as for translation and summarization. These examples are not intended to be limiting, and any architecture type-including but not limited to those described herein—may be implemented depending on the particular embodiment and the task(s) being performed using the model(s).

In various embodiments, the LLMs/VLMs/etc. may be trained using unsupervised learning, in which an LLM learns patterns from large amounts of unlabeled text/audio/video/image/etc. data. Due to the extensive training, in embodiments, the models may not require task-specific or domain-specific training. LLMs that have undergone extensive pre-training on vast amounts of unlabeled text data may be referred to as foundation models and may be adept at a variety of tasks like question-answering, summarization, filling in missing information, and translation. Some LLMs may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/etc. of the present disclosure may be implemented using various model alignment techniques. For example, in some embodiments, guardrails may be implemented to identify improper or undesired inputs (e.g., prompts) and/or outputs of the models. In some non-limiting embodiments, the guardrails implemented may be similar to those described in U.S. Pat. App. No. 18,304,341, filed on Apr. 20, 2023, the contents of which are hereby incorporated by reference in their entirety. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/etc. of the present disclosure may be less likely to output language/text/audio/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 5A is a block diagram of an example generative language model system 500 suitable for use in implementing at least some embodiments of the present disclosure. In the example illustrated in FIG. 5A, the generative language model system 500 includes a retrieval augmented generation (RAG) component 592, an input processor 505, a tokenizer 510, an embedding component 520, plug-ins/APIs 595, and a generative language model (LM) 530 (which may include an LLM, a VLM, a multi-modal LM, etc.).

At a high level, the input processor 505 may receive an input 501 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 530. In some embodiments, the input 501 includes plain text in the form of one or more sentences, paragraphs, and/or documents. Additionally or alternatively, the input 501 may include numerical sequences, precomputed embeddings (e.g., word or sentence embeddings), and/or structured data (e.g., in tabular formats, JSON, or XML). In some implementations in which the generative LM 530 is capable of processing multimodal inputs, the input 501 may combine text with image data, audio data, and/or other types of input data, such as but not limited to those described herein. Taking raw input text as an example, the input processor 505 may prepare raw input text in various ways. For example, the input processor 505 may perform various types of text filtering to remove noise (e.g., special characters, punctuation, HTML tags, stopwords) from relevant textual content. In an example involving stopwords (common words that tend to carry little semantic meaning), the input processor 505 may remove stopwords to reduce noise and focus the generative LM 530 on more meaningful content. The input processor 505 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 592 may be used to retrieve additional information to be used as part of the input 501 or prompt. For example, in some embodiments, the input 501 may be generated using the query or input to the model (e.g., a question, a request, etc.) in addition to data retrieved using the RAG component 592. In some embodiments, the input processor 505 may analyze the input 501 and communicate with the RAG component 592 (or the RAG component 592 may be part of the input processor 505, in embodiments) in order to identify relevant text and/or other data to provide to the generative LM 530 as additional context or sources of information from which to identify the response, answer, or output 590, generally. For example, where the input indicates that the user is interested in a desired tire pressure for a particular make and model of vehicle, the RAG component 592 may retrieve—using a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 592 may retrieve a prior stored conversation history—or at least a summary thereof—and include the prior conversation history along with the current ask/request as part of the input 501 to the generative LM 530.

The tokenizer 510 may segment the (e.g., processed) text into smaller units (tokens) for subsequent analysis and processing. The tokens may represent individual words, subwords, characters, etc., depending on the implementation. Word-based tokenization divides the text into individual words, treating each word as a separate token. Subword tokenization breaks down words into smaller meaningful units (e.g., prefixes, suffixes, stems), enabling the generative LM 530 to understand morphological variations and handle out-of-vocabulary words more effectively. Character-based tokenization represents each character as a separate token, enabling the generative LM 530 to process text at a fine-grained level. The choice of tokenization strategy may depend on factors such as the language being processed, the task at hand, and/or characteristics of the training dataset. As such, the tokenizer 510 may convert the (e.g., processed) text into a structured format according to tokenization schema being implemented in the particular embodiment.

The embedding component 520 may use any known embedding technique to transform discrete tokens into (e.g., dense, continuous vector) representations of semantic meaning. For example, the embedding component 520 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 501 includes image data, the input processor 501 may resize the image data to a standard size compatible with format of a corresponding input channel and/or may normalize pixel values to a common range (e.g., 0 to 1) to ensure a consistent representation, and the embedding component 520 may encode the image data using any known technique (e.g., using one or more convolutional neural networks (CNNs) to extract visual features). In some implementations in which the input 501 includes audio data, the input processor 501 may resample an audio file to a consistent sampling rate for uniform processing, and the embedding component 520 may use any known technique to extract and encode audio features—such as in the form of a spectrogram (e.g., a mel-spectrogram). In some implementations in which the input 501 includes video data, the input processor 501 may extract frames or apply resizing to extracted frames, and the embedding component 520 may extract features such as optical flow embeddings or video embeddings and/or may encode temporal information or sequences of frames. In some implementations in which the input 501 includes multimodal data, the embedding component 520 may fuse representations of the different types of data (e.g., text, image, audio) using techniques like early fusion (concatenation), late fusion (sequential processing), attention-based fusion, etc.

The generative LM 530 and/or other components of the generative LLM system 500 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 520 may apply an encoded representation of the input 501 to the generative LM 530, and the generative LM 530 may process the encoded representation of the input 501 to generate an output 590, which may include responsive text and/or other types of data.

As described herein, in some embodiments, the generative LM 530 may be configured to access or use—or capable of accessing or using—plug-ins/APIs 595 (which may include one or more plug-ins, application programming interfaces (APIs), databases, data stores, repositories, etc.). For example, for certain tasks or operations that the generative LM 530 is not ideally suited for, the model may have instructions (e.g., as a result of training, and/or based on instructions in a given prompt, such as those retrieved using the RAG component 592) to access one or more plug-ins/APIs 595 (e.g., third party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 595 to the plug-in/API 595, the plug-in/API 595 may process the information and return an answer to the generative LM 530, and the generative LM 530 may use the response to generate the output 590. This process may be repeated—e.g., recursively—for any number of iterations and using any number of plug-ins/APIs 595 until an output 590 that addresses each ask/question/request/process/operation/etc. from the input 501 can be generated. As such, the model(s) may not only rely on its own knowledge from training on a large dataset(s) and/or from data retrieved using the RAG component 592, but also on the expertise or optimized nature of one or more external resources—such as the plug-ins/APIs 595.

FIG. 5B is a block diagram of an example implementation in which the generative LM 530 includes a transformer encoder-decoder. For example, assume input text such as “Who discovered gravity” is tokenized (e.g., by the tokenizer 510 of FIG. 5A) into tokens such as words, and each token is encoded (e.g., by the embedding component 520 of FIG. 5A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 535 of the generative LM 530.

In an example implementation, the encoder(s) 535 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 540 may convert the context vector into attention vectors (keys and values) for the decoder(s) 545.

In an example implementation, the decoder(s) 545 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 535, in an example transformer architecture, each token (e.g., word) flows through a separate path in the decoder(s) 545. During a first pass, the decoder(s) 545, a classifier 550, and a generation mechanism 555 may generate a first token, and the generation mechanism 555 may apply the generated token as an input during a second pass. The process may repeat in a loop, successively generating and adding tokens (e.g., words) to the output from the preceding pass and applying the token embeddings of the composite sequence with positional encodings as an input to the decoder(s) 545 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 535, except that it creates its queries from the layer below it and takes the keys and values (e.g., matrix) from the output of the encoder(s) 535.

As such, the decoder(s) 545 may output some decoded (e.g., vector) representation of the input being applied during a particular pass. The classifier 550 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 555 may select or sample a word or token based on a corresponding predicted probability (e.g., select the word with the highest predicted probability) and append it to the output from a previous pass, generating each word or token sequentially. The generation mechanism 555 may repeat the process, triggering successive decoder inputs and corresponding predictions until selecting or sampling a symbol or token that represents the end of the response, at which point, the generation mechanism 555 may output the generated response.

FIG. 5C is a block diagram of an example implementation in which the generative LM 530 includes a decoder-only transformer architecture. For example, the decoder(s) 560 of FIG. 5C may operate similarly as the decoder(s) 545 of FIG. 5B except each of the decoder(s) 560 of FIG. 5C omits the encoder-decoder self-attention layer (since there is no encoder in this implementation). As such, the decoder(s) 560 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 560. As with the decoder(s) 545 of FIG. 5B, each token (e.g., word) may flow through a separate path in the decoder(s) 560, and the decoder(s) 560, a classifier 565, and a generation mechanism 570 may use auto-regression to sequentially generate one token at a time until predicting a symbol or token that represents the end of the response. The classifier 565 and the generation mechanism 570 may operate similarly as the classifier 550 and the generation mechanism 555 of FIG. 5B, with the generation mechanism 570 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

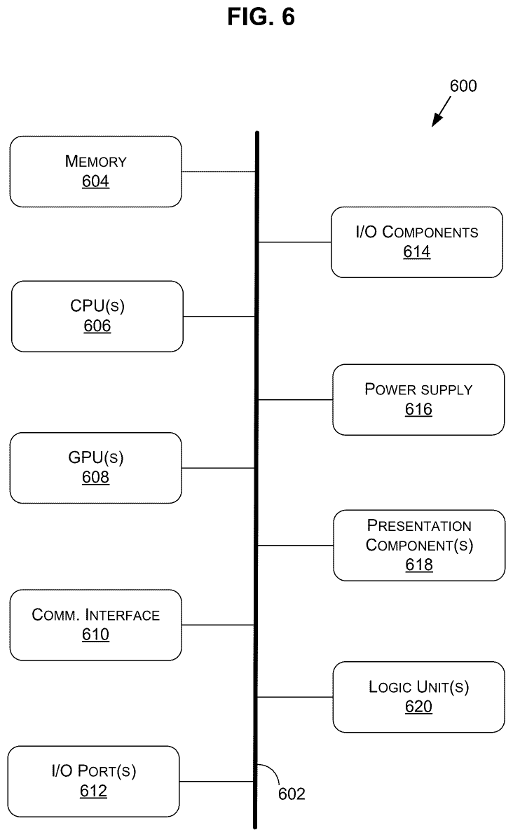

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using a communication interface such as NVIDIA® NVLink®) or may connect the GPUs through a switch (e.g., using a communication interface switch such as NVIDIA® NVSwitch®). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs), one or more decoupled accelerators (e.g., decoupled lookup table (DLUT) accelerators), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that allow the computing device 600 to communicate with other computing devices via an electronic communication network, included wired and/or wireless communications. The communication interface 610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may allow the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that allow detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to allow the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

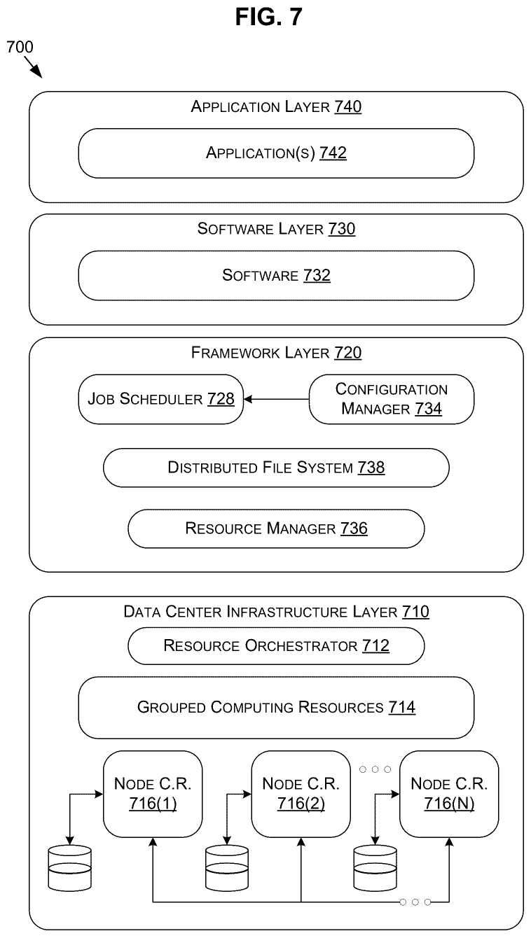

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R. s”) 716(1)-716(N), where “N” represents any whole, positive integer. In at least one embodiment, node C.R. s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R. s from among node C.R. s 716(1)-716(N) may correspond to a server having one or more of the above-mentioned computing resources. In addition, in some embodiments, the node C.R. s 716(1)-716(N) may include one or more virtual components, such as vGPUs, vCPUs, and/or the like, and/or one or more of the node C.R. s 716(1)-716(N) may correspond to a virtual machine (VM).

In at least one embodiment, grouped computing resources 714 may include separate groupings of node C.R. s 716 housed within one or more racks (not shown), or many racks housed in data centers at various geographical locations (also not shown). Separate groupings of node C.R. s 716 within grouped computing resources 714 may include grouped compute, network, memory or storage resources that may be configured or allocated to support one or more workloads. In at least one embodiment, several node C.R. s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R. s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may use distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R. s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R. s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including handheld devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A system comprising:
a memory device; and
at least one processing device, coupled to the memory device, to perform operations comprising:
receiving one or more executable files implementing an artificial intelligence (AI) model;
scanning the one or more executable files implementing the AI model to identify a target attribute of the AI model;
executing one or more tests in a testing environment associated with a computing system hosting the AI model to generate test data associated with the target attribute; and
generating, based on the test data, a damage likelihood score associated with the target attribute of the AI model.

2. The system of claim 1, the operations further comprising generating, during implementation of the AI model in a production environment associated with the computing system, usage data associated with the AI model.

3. The system of claim 2, the operations further comprising adjusting the damage likelihood score based on the usage data.

4. The system of claim 1, the operations further comprising:
collecting historical security incident data associated an identified attribute; and
correlating the identified attribute to the target attribute.

5. The system of claim 4, the operations comprising adjusting the damage likelihood score based on the historical security incident data.

6. The system of claim 1, the operations further comprising determining the damage likelihood score satisfies a condition.

7. The system of claim 6, the operations further comprising generating an alert in response to determining the damage likelihood score satisfies the condition.

8. The system of claim 7, the operations further comprising executing, based on the alert, a remedial action with respect to the computing system.

9. A method comprising:
receiving, by at least one processing device, one or more executable files implementing an artificial intelligence (AI) model;
scanning the one or more executable files implementing the AI model to identify a target attribute of the AI model;
executing one or more tests in a testing environment associated with a computing system hosting the AI model to generate test data associated with the target attribute; and
generating, based on the test data, a damage likelihood score associated with the target attribute of the AI model.

10. The method of claim 9, further comprising generating, during implementation of the AI model in a production environment associated with the computing system, usage data associated with the AI model.

11. The method of claim 10, further comprising adjusting the damage likelihood score based on the usage data.

12. The method of claim 9, further comprising:
collecting historical security incident data associated an identified attribute; and
correlating the identified attribute to the target attribute.

13. The method of claim 12, further comprising adjusting the damage likelihood score based on the historical security incident data.

14. The method of claim 9, further comprising determining the damage likelihood score satisfies a condition.

15. The method of claim 14, further comprising generating an alert in response to determining the damage likelihood score satisfies the condition.

16. The method of claim 15, further comprising executing, based on the alert, a remedial action with respect to the computing system.

17. A non-transitory computer readable storage medium comprising instructions that, when executed by at least one processing device, cause the at least one processing device to perform operations comprising:
receiving one or more executable files implementing an artificial intelligence (AI) model;
scanning the one or more executable files implementing the AI model to identify a target attribute of the AI model;
executing one or more tests in a testing environment associated with a computing system hosting the AI model to generate test data associated with the target attribute; and
generating, based on the test data, a damage likelihood score associated with the target attribute of the AI model.

18. The non-transitory computer readable storage medium of claim 17, the operations further comprising:
generating, during implementation of the AI model in a production environment associated with the computing system, usage data associated with the AI model; and
adjusting the damage likelihood score based on the usage data.

19. The non-transitory computer readable storage medium of claim 17, the operations further comprising:
collecting historical security incident data associated an identified attribute;
correlating the identified attribute to the target attribute; and
adjusting the damage likelihood score based on the historical security incident data.

20. The non-transitory computer readable storage medium of claim 17, the operations further comprising:
determining the damage likelihood score satisfies a condition;
generating an alert in response to determining the damage likelihood score satisfies the condition; and
executing, based on the alert, a remedial action with respect to the computing system.
